(19) United States
(12) Patent Application Publication
(10) Pub. No.: US 2010/0231456 A1
(43) Pub. Date: Sep. 16, 2010

(54) MOBILE COMMUNICATION ANTENNA WITH REDUCED GROUNDPLANE EFFECTS

(75) Inventors: Kin-Lu Wong, Taipei Hsien (TW); Cheng-Tse Lee, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: ACER INCORPORATED, Taipei Hsien (TW)

(21) Appl. No.: 12/536,532

(22) Filed: Aug. 6, 2009

(30) Foreign Application Priority Data
Mar. 11, 2009 (TW) 098107838

(51) Int. Cl. H01Q 1/38

(52) U.S. Cl. 343/700 MS

(57) ABSTRACT

The present invention is related to a mobile communication antenna with reduced ground plane effects. The antenna comprises a dielectric substrate, a first ground plane, a radiating element, a second ground plane, and a slit. The first ground plane is disposed on the dielectric substrate. The radiating element is disposed on the dielectric substrate or nearby the dielectric substrate and is connected to a signal source disposed on the dielectric substrate. The second ground plane is disposed nearby one edge of the first ground plane and is connected to the first ground plane through a metal strip. The slit is disposed on the second ground plane and is nearby the metal strip.

### BACKGROUND OF THE INVENTION

1. Field of the Invention

The present invention is related to a mobile communication antenna; in particular, to a mobile communication antenna with reduced ground plane effects.

2. Description of Related Art

As the development and progress in wireless communication technologies continue to grow, various wireless communication products emerge and mobile phones become increasingly popular. Currently available mobile phones are commonly classified as bar-type, folder-type and slider-type. Among different types of mobile phone, since the system ground plane used in the mobile devices varies, the antenna applied thereto may be different as well. Taking the folder-type mobile phone as an example, compared to the bar-type mobile phone, the system ground plane thereof is formed by the upper board ground plane and the main board ground plane; therefore, if directly applying the antenna in the bar-type mobile phone to the folder-type mobile phone, the antenna needs to be adjusted or re-designed, which may increase additional research and development costs. For example, the U.S. Pat. No. 6,750,821 B2, titled “Folded Dual-Band Antenna Apparatus” is disclosed an antenna design applied in the bar-type mobile phone; however, if such an antenna is directly applied in a folder-type mobile phone, it is required to adjust the antenna parameters, causing undesirable increase in R&D costs.

Different from the traditional antenna designs, the antenna according to the present invention provides a mobile communication antenna with reduced ground plane effects, which intends to directly apply the antenna design used in the bar-type mobile phone to the folder-type mobile phone, in which it is possible that the antenna performances can be very slightly affected by the large variations in the system ground plane; as a result, without modifying the antenna design, the antenna performances thereof become similar to those obtained when applied in the bar-type mobile phone, thereby the antenna according to the present invention can meet the requirements of modern mobile phones.

### SUMMARY OF THE INVENTION

The objective of the present invention is to provide a mobile communication antenna with reduced ground plane effects, which can reduce the effects on the antenna performances caused by the upper board ground plane of the folder-type mobile phone.

The antenna according to the present invention comprises: a dielectric substrate, a first ground plane, a radiating element, a second ground plane and a slit. The first ground plane is formed on the dielectric substrate by etching or printing; the radiating element is disposed on the dielectric substrate or nearby the dielectric substrate, with the radiating element being also electrically connected to a signal source disposed on the dielectric substrate; the second ground plane is disposed nearby one edge of the first ground plane and electrically connected thereto through a metal strip; the slit is disposed on the second ground plane and nearby the metal strip.

The focus of the antenna design according to the present invention is to directly apply the antenna used in the bar-type mobile phone to the folder-type mobile phone without modification or redesign in the antenna, meanwhile the good performances of the antenna can be effectively maintained. The design technique of the antenna according to the present invention lies in placing the radiating element of the antenna on or nearby the main board, and configuring a slit nearby the metal strip connecting the upper board ground plane (second ground plane) and the main board ground plane (first ground plane), with the slit possibly being disposed on the upper board ground plane or on the main board ground plane, both allowing the surface current distribution of the upper board ground plane excited by the radiating element in the antenna to be confined nearby the slit, while significantly reducing the surface current distribution in other parts of the upper board ground plane, thus greatly decreasing the effective length and area of the upper board ground plane with regards to the antenna, thereby reducing the effects of the upper board ground plane on the antenna performances. When utilizing the antenna according to the present invention to the folder-type mobile phone, since the configuration of the slit can greatly reduce the effects caused by upper board ground plane, the performances of the antenna consequently become similar to those of the antenna used in the bar-type mobile phone; besides, the antenna according to the present invention presents good antenna performances, no matter the mobile phone is in an open state (the talk condition) or in a closed state (the idle condition).

### BRIEF DESCRIPTION OF THE DRAWINGS

FIG. 1 is a structure diagram for a first embodiment of the antenna according to the present invention.

FIG. 2 is a structure diagram for a second embodiment of the antenna according to the present invention.

FIG. 3 is a return loss diagram for the second embodiment of the antenna according to the present invention.

FIG. 4 is a structure diagram for a third embodiment of the antenna according to the present invention (as two ground planes in the second embodiment being parallel).

FIG. 5 is a return loss diagram for the third embodiment of the antenna according to the present invention.

FIG. 6 is a structure diagram for a fourth embodiment of the antenna according to the present invention.

FIG. 7 is a structure diagram for a fifth embodiment of the antenna according to the present invention.

FIG. 8 is a structure diagram for a sixth embodiment of the antenna according to the present invention.

FIG. 9 is a structure diagram for a seventh embodiment of the antenna according to the present invention.

### DETAILED DESCRIPTION OF THE PREFERRED EMBODIMENTS

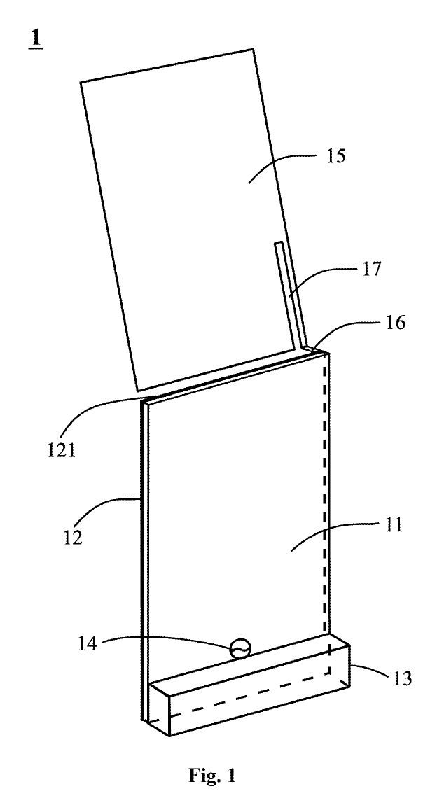

FIG. 1 is a structure diagram for a first embodiment of the antenna according to the present invention, comprising: a dielectric substrate 11, a first ground plane 12, a radiating element 13, a second ground plane 15 and a slit 17. The first ground plane 12 is formed on the dielectric substrate 11 by etching or printing; the radiating element 13 is disposed on the dielectric substrate 11 or nearby the dielectric substrate 11, with the radiating element 13 being also electrically connected to a signal source 14 disposed on the dielectric substrate 11; the second ground plane 15 is disposed nearby one edge 121 of the first ground plane and electrically connected to the first ground plane 12 through a metal strip 16; the slit 17 is disposed on the second ground plane 15 and nearby the metal strip 16. The length and width of the slit 17 should be at least 20 mm and 0.3 mm, respectively.

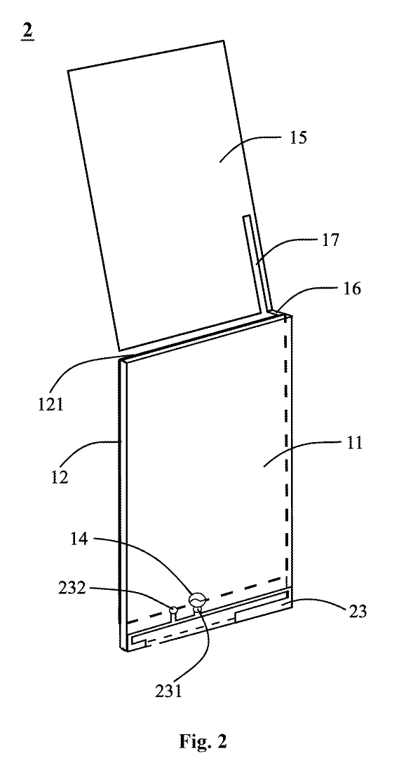

FIG. 2 is a structure diagram for a second embodiment of the antenna according to the present invention, comprising: a dielectric substrate 11, a first ground plane 12, a radiating element 23, a second ground plane 15 and a slit 17. The first ground plane 12 is formed on the dielectric substrate 11 by etching or printing; the radiating element 23 is formed on the dielectric substrate 11 by etching or printing, and can be a radiating element such as a dual-band antenna or a shorted monopole antenna. The radiating element 23 has an antenna feeding point 231 and a shorting point 232, in which the antenna feeding point 231 is electrically connected to a signal source 14 disposed on the dielectric substrate 11, and the shorting point 232 is electrically connected to the first ground plane 12; the second ground plane 15 is disposed nearby one edge 121 of the first ground plane and electrically connected to the first ground plane 12 through a metal strip 16; the slit 17 is disposed on the second ground plane 15 and nearby the metal strip 16. The length and width of the slit 17 should be at least 20 mm and 0.3 mm, respectively.

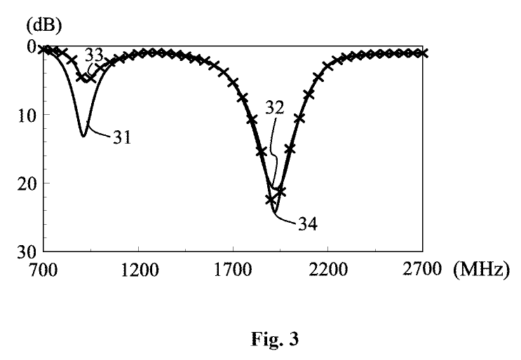

FIG. 3 is a return loss diagram for the second embodiment of the antenna according to the present invention. Herein the horizontal axis represents the operating frequency, and the vertical axis indicates the return loss. The present embodiment uses a first ground plane 12 which is approximately 100 mm in length and approximately 60 mm in width, etched or printed on a glass fiber dielectric substrate 11 of 0.8 mm in thickness; a radiating element having an area of about 10×60 mm², etched or printed on the glass fiber dielectric substrate 11; a second ground plane 15 having a length of about 100 mm and a width of about 60 mm, electrically connected to the first ground plane 12 through a metal strip 16; a slit 17 having a length of about 35 mm and a width of about 1.5 mm. From the measurements obtained in the experiment, it can be observed that, with the definition of 6 dB return loss, the first operating band 31 in the second embodiment of the antenna according to the present invention covers GSM850/900 (824˜894/890˜960 MHz), and the second operating band 32 therein covers GSM1800/1900 (1710˜1880/1850˜1990 MHz). It is noted that when the slit 17 is not present in the second embodiment, the performances of the radiating element 23 is significantly affected by the second ground plane 15; hence it can be seen from FIG. 3 that the bandwidth of the first operating band 33 is greatly decreased, unable to cover GSM850/900 band, while the effects on the second operating band are small.

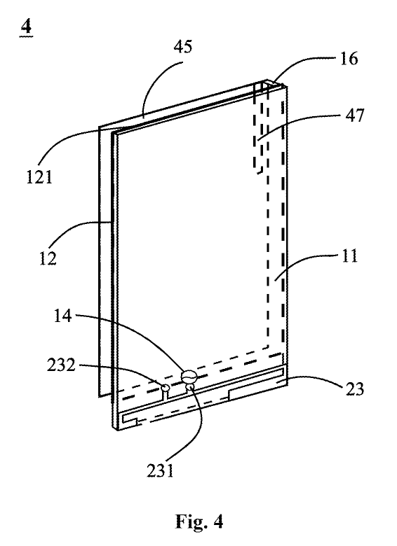

FIG. 4 is a structure diagram for a third embodiment of the antenna according to the present invention, wherein the first ground plane 12 and the second ground plane 45 are parallel, and other structures in the present antenna are the same as those in the antenna of the second embodiment.

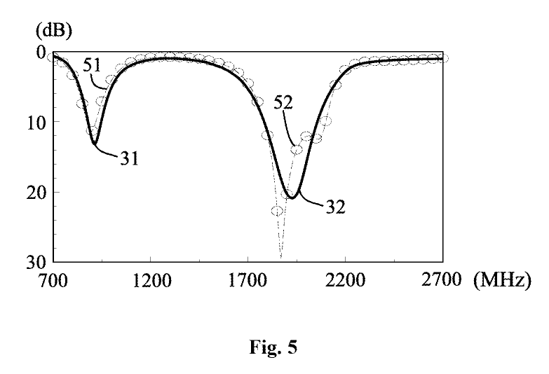

FIG. 5 is a return loss diagram for the third embodiment of the antenna according to the present invention. From the measurements obtained in the experiment, with the definition of 6 dB return loss, the first operating band 51 in the third embodiment and the first operating band 31 in the second embodiment both cover GSM850/900 band, and the second operating band 52 in the third embodiment and the second operating band 32 in the second embodiment both also cover GSM1800/1900 band. Here it is noted that due to the configuration of the slit 47 in the third embodiment of the antenna according to the present invention, the performances of the radiating element 23 is very slightly affected by the second ground plane 45.

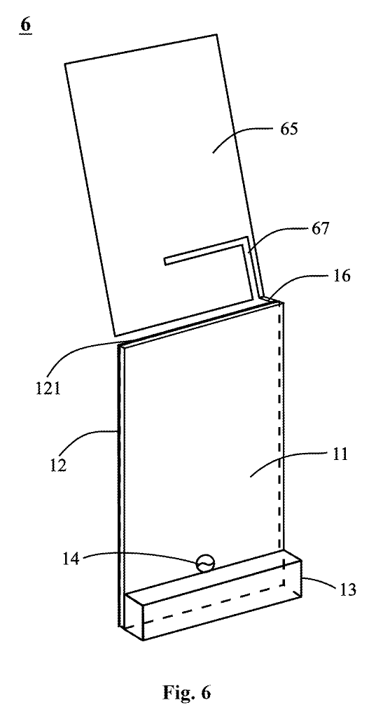

FIG. 6 is a structure diagram for a fourth embodiment of the antenna according to the present invention, wherein the slit 67 is L-shaped, while other structures of the antenna are similar to those of the antenna in the first embodiment. The fourth embodiment of the antenna according to the present invention may also achieve results similar to the ones provided by the first embodiment.

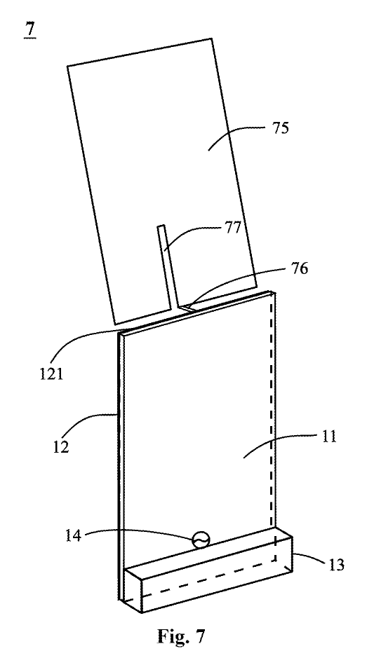

FIG. 7 is a structure diagram for a fifth embodiment of the antenna according to the present invention, wherein both the metal strip 76 and the slit 77 are approximately disposed at the center of the second ground plane 75, but the slit 77 is still positioned nearby the metal strip 76, and other structures of the antenna are similar to those of the first embodiment. The fifth embodiment of the antenna according to the present invention may also achieve results similar to the ones provided by the first embodiment.

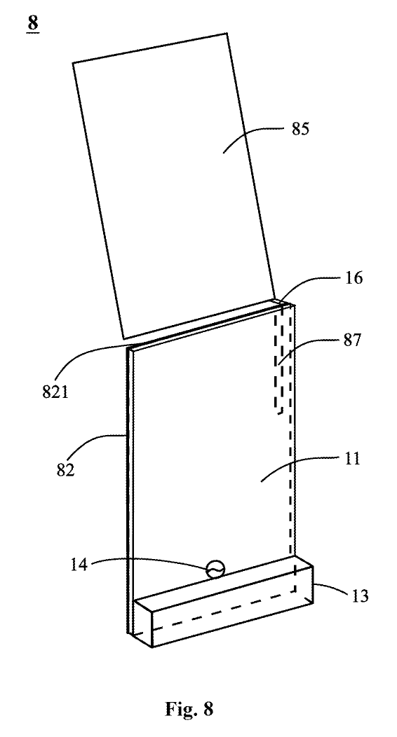

FIG. 8 is a structure diagram for a sixth embodiment of the antenna according to the present invention, wherein the slit 87 is disposed on the first ground plane 82, and other structures of the present antenna are similar to those of the first embodiment. The sixth embodiment of the antenna according to the present invention may also achieve results similar to the ones provided by the first embodiment.

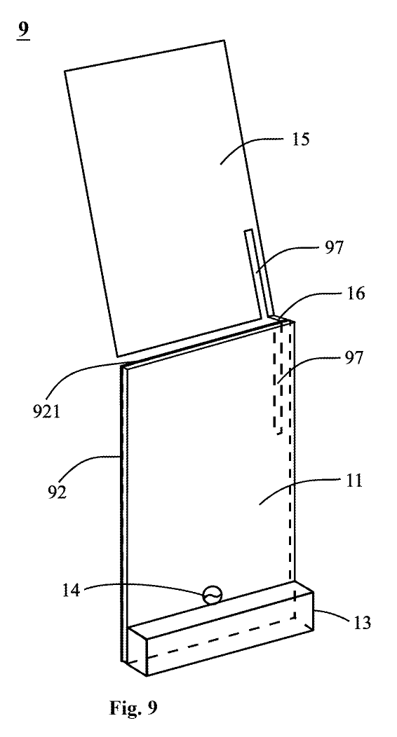

FIG. 9 is a structure diagram for a seventh embodiment of the antenna according to the present invention, wherein the slit 97 can be simultaneously disposed on the first ground plane 92 and the second ground plane 15, and other structures of the present antenna are similar to those of the first embodiment. The seventh embodiment of the antenna according to the present invention may also achieve results similar to the ones provided by the first embodiment.

The embodiments illustrated hereinbefore are simply for the purpose of describing the principle of the present invention and effects thereof, rather than for limiting the present invention. Hence, those skilled ones in the art can perform modifications and changes to the above-mentioned embodiments without departing from the spirit of the present invention. The scope of the present invention should be delineated by the claims set forth hereinafter.

What is claimed is:

1. A mobile communication antenna with reduced ground plane effects, comprising:
a dielectric substrate;
a first ground plane, disposed on the dielectric substrate;
a radiating element, disposed on the dielectric substrate or nearby the dielectric substrate, the radiating element being electrically connected to a signal source disposed on the dielectric substrate;
a second ground plane, disposed nearby one edge of the first ground plane and electrically connected to the first ground plane through a metal strip; and
a slit, disposed on the second ground plane and nearby the metal strip.

2. The mobile communication antenna according to claim 1, wherein the first ground plane is formed on the dielectric substrate by etching or printing.

3. The mobile communication antenna according to claim 1, wherein the length of the slit is at least 20 mm.

4. The mobile communication antenna according to claim 1, wherein the width of the slit is at least 0.3 mm.

5. A mobile communication antenna with reduced ground plane effects, comprising:
a dielectric substrate;
a first ground plane, disposed on the dielectric substrate;
a radiating element, disposed on the dielectric substrate or nearby the dielectric substrate, the radiating element being electrically connected to a signal source disposed on the dielectric substrate;
a second ground plane, disposed nearby one edge of the first ground plane and electrically connected to the first ground plane through a metal strip; and
a slit, disposed on the first ground plane and nearby the metal strip.

6. The mobile communication antenna according to claim 5, wherein the first ground plane is formed on the dielectric substrate by etching or printing.

7. The mobile communication antenna according to claim 5, wherein the length of the slit is at least 20 mm.

8. The mobile communication antenna according to claim 5, wherein the width of the slit is at least 0.3 mm.
